(19) United States
(12) Patent Application Publication
(10) Pub. No.: US 2007/0037680 A1
(43) Pub. Date: Feb. 15, 2007

(54) Conductive roller and image forming apparatus comprising the same

(75) Inventors: Hirotaka Tagawa, Yokohama-shi (JP); Kouta Kawano, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 11/500,285

(22) Filed: Aug. 8, 2006

(30) Foreign Application Priority Data
Aug. 11, 2005 (JP) 2005-233,214

(51) Int. Cl. F16C 13/00

(52) U.S. Cl. 492/56

(57) ABSTRACT

In a conductive roller comprising a metal shaft and an elastic layer formed thereon, the elastic layer contains a monovalent tetrafluoroborate.

### TECHNICAL FIELD

This invention relates to a conductive roller having a metal shaft and an elastic layer and an image forming apparatus comprising the same, and more particularly to a conductive roller suppressing an occurrence of rust in the metal shaft.

### BACKGROUND ART

In general, a roll-shaped conductive member, i.e. a conductive roller is frequently used as a developing roller, a charging roller, a toner feed roller, a transfer roller, a paper feed roller, a cleaning roller, a pressure roller for fixing or the like in an image forming apparatus of an electro-photographic type such as a copying machine, a facsimile, a printer or the like. The conductive roller usually comprises a shaft and an elastic layer disposed on the outer periphery of the shaft.

Since the shaft of the conductive roller is usually made of a metal, it is subjected to a rust preventive treatment. Although a chromate treatment is common as the conventional method for the rust preventive treatment of the metal shaft, other treatments are studied with a recent increasing interest in an environment and a health. However, the other treatments are insufficient in the rust preventive effect, so that they have a problem that the rust easily occurs on the surface of the metal shaft.

Moreover, as the elastic layer of the conductive roller is used a composition using an elastomer such as polyurethane, silicone rubber, acrylonitrile-butadiene rubber (NBR), ethylene-propylene-diene rubber (EPDM), epichlorohydrin rubber (ECO) or the like, or a foam formed by foaming such an elastomer as a main component and adding with an electron conductive agent such as carbon black or the like and an ion conductive agent such as perchlorate, quaternary ammonium salt or the like for the provision of an electrical conductivity. When the electron conductive agent such as carbon black or the like is used in the elastic layer, there is a problem that the electrical conductivity of the elastic layer greatly depends on the environment. On the other hand, when the ion conductive agent is used in the elastic layer, there is an advantage that the dependence of the electrical conductivity of the elastic layer on the environment can be reduced (See JP-A-H10-10764).

### DISCLOSURE OF THE INVENTION

As a result of the inventors' studies, however, it has been found that since the perchlorate or the quaternary ammonium salt conventionally used as the ion conductive agent is strong in the oxidative force, if the conductive roller comprising the metal shaft and the elastic layer added with such an ion conductive agent is left to stand under high-temperature and high-humidity conditions, there is a problem of generating the rust on the surface of the shaft. When the rust is generated on the surface of the shaft, there are problems that the adhesiveness between the shaft and the elastic layer is deteriorated and further the elastic layer is peeled off from the shaft to cause bad conductivity and defective shape of the roller.

It is, therefore, an object of the invention to solve the above-mentioned problems of the conventional techniques and to provide a conductive roller comprising a metal shaft and an elastic layer and suppressing an occurrence of the rust on the metal shaft under high-temperature and high-humidity conditions. Moreover, it is another object of the invention to provide an image forming apparatus comprising such a conductive roller and capable of stably forming a good image because the bad conductivity and defective shape of the roller are prevented.

The inventors have made various studies in order to achieve the above objects and discovered that a weakly oxidative monovalent tetrafluoroborate is selected as an ion conductive agent to be added to the elastic layer in the conductive roller comprising the metal shaft and the elastic layer composed of a polyurethane foam or a polyurethane elastomer, whereby the rust is not generated on the surface of the metal shaft and the bad conductivity and defective shape of the conductive roller can be prevented even if the conductive roller is left to stand under high-temperature and high-humidity conditions, and as a result, the invention has been accomplished.

That is, the conductive roller according to the invention comprises a metal shaft and an elastic layer formed on the outer periphery of the metal shaft and composed of a polyurethane foam or a polyurethane elastomer, characterized in that the elastic layer contains a monovalent tetrafluoroborate.

In a preferable embodiment of the conductive roller according to the invention, the monovalent tetrafluoroborate is at least one selected from the group consisting of lithium tetrafluoroborate, sodium tetrafluoroborate and potassium tetrafluoroborate.

In another preferable embodiment of the conductive roller according to the invention, the elastic layer is formed by a prepolymer process using a polyurethane raw material comprising 1-50 parts by mass of a polyol and 0.1-10 parts by mass of the monovalent tetrafluoroborate based on 100 parts by mass of an urethane prepolymer synthesized from a polyol and a polyisocyanate.

In another preferable embodiment of the conductive roller according to the invention, the elastic layer is formed by a one-shot process using a polyurethane raw material comprising 1-50 parts by mass of a polyisocyanate and 0.1-10 parts by mass of the monovalent tetrafluoroborate based on 100 parts by mass of a polyol.

In the other preferable embodiment of the conductive roller according to the invention, the elastic layer is a polyurethane foam obtained by foaming the polyurethane raw material with mechanical stirring.

Also, the image forming apparatus according to the invention is characterized by comprising the above-described conductive roller. It is preferable that the conductive roller is used as at least any one of a developing roller, a charging roller, a toner supplying roller and a transfer roller.

According to the invention, there can be provided a conductive roller comprising a metal shaft and an elastic layer composed of a polyurethane foam or a polyurethane elastomer containing a monovalent tetrafluoroborate as an ion conductive agent and suppressing the occurrence of the rust on the metal shaft under high-temperature and high-humidity conditions. Moreover, there can be provided an image forming apparatus comprising such a conductive roller and capable of stably forming a good image.

### BRIEF DESCRIPTION OF THE DRAWING

FIG. 1 is a schematic view partly shown in section of an embodiment of the image forming apparatus according to the invention.

### BEST MODE FOR CARRYING OUT THE INVENTION

<Conductive Roller>

The conductive roller according to the invention will be described in detail below. The conductive roller according to the invention comprises a metal shaft and an elastic layer formed on the outer periphery of the metal shaft and composed of a polyurethane foam or a polyurethane elastomer, in which the elastic layer contains a monovalent tetrafluoroborate. The elastic layer of the conductive roller according to the invention is small in the dependence of the electrical conductivity on the environment because it contains an ion conductive agent. Also, the elastic layer of the conductive roller according to the invention contains the weakly oxidative monovalent tetrafluoroborate as the ion conductive agent, so that the rust is hardly generated on the surface of the metal shaft even if the roller is left to stand under high-temperature and high-humidity conditions over the long term. Therefore, the chromate treatment badly exerting on the environment can be eliminated.

In the conductive roller of the invention, the material of the metal shaft is not particularly limited as far as it has a good electrical conductivity, and includes, for example, iron, stainless steel, aluminum and so on. Also, the metal shaft may be a core metal made of a metallic solid body or a hollow metal cylinder.

The elastic layer of the conductive roller according to the invention is composed of the polyurethane foam or the polyurethane elastomer containing the monovalent tetrafluoroborate and may further contain known additives such as a catalyst, a foam stabilizer, an electron conductive agent and so on.

The elastic layer may be formed by a prepolymer process using a polyurethane raw material containing an urethane prepolymer and a polyol or by a one-shot process using a polyurethane raw material containing a polyol and a polyisocyanate. Moreover, in case of forming the elastic layer composed of the polyurethane foam, it is preferably formed by foaming the polyurethane raw material with mechanical stirring (mechanical froth method).

The polyol used as the polyurethane raw material is a compound having plural hydroxyl groups. As the polyol are concretely mentioned polyether polyol, polyester polyol, polytetramethylene glycol, polybutadiene polyol, alkylene oxide-modified polybutadiene polyol, polyisoprene polyol and so on. For example, the polyether polyol can be obtained by adding an alkylene oxide such as ethylene oxide, propylene oxide or the like to a polyalcohol such as ethylene glycol, propylene glycol, glycerin or the like. Also, the polyester polyol can be obtained, for example, from a polyalcohol such as ethylene glycol, diethylene glycol, 1,4-butanediol, 1,6-hexanediol, propylene glycol, trimethylolethane, trimethylolpropane or the like and a polybasic carboxylic acid such as adipic acid, glutaric acid, succinic acid, sebacic acid, pimelic acid, suberic acid or the like. These polyols may be used alone or in a combination of two or more.

The polyisocyanate which may be used as the polyurethane raw material is a compound having plural isocyanate groups. As the polyisocyanate are concretely mentioned tolylene diisocyanate (TDI), diphenylmethane diisocyanate (MDI), crude diphenylmethane diisocyanate (crude MDI), isophorone diisocyanate (IPDI), hydrogenated diphenylmethane diisocyanate, hydrogenated tolylene diisocyanate and hexamethylene diisocyanate (HDI), as well as their isocyanurate-modified compounds, carbodiimide-modified compounds, glycol-modified compounds and so on. These polyisocyanates may be used alone or in a combination of two or more.

The urethane prepolymer which may be used as the polyurethane raw material is synthesized from the polyol and the polyisocyanate. In the synthesis of the urethane prepolymer, a ratio of the polyol to the polyisocyanate can be properly selected for any purpose. In the urethane prepolymer, the NCO (isocyanate group) content is preferable to be within a range of 1-10%.

The amount of the polyisocyanate or the urethane prepolymer used is preferable to be properly selected so that the ratio (NCO/OH) of the isocyanate group (NCO) of the polyisocyanate or the urethane prepolymer to the hydroxyl group (OH) of the polyol is within a range of 90/100-120/100.

The elastic layer of the conductive roller according to the invention is required to contain the monovalent tetrafluoroborate. As the monovalent tetrafluoroborate are preferable alkali metal tetrafluoroborates from a viewpoint of the improving effect of the electrical conductivity of the elastic layer, and particularly lithium tetrafluoroborate (LiBF₄), sodium tetrafluoroborate (NaBF₄) and potassium tetrafluoroborate (KBF₄) are preferable. These monovalent tetrafluoroborates may be used alone or in a combination of two or more.

When the elastic layer is formed by the prepolymer process, the polyurethane raw material to be used is preferable to contain 1-50 parts by mass of the polyol and 0.1-10 parts by mass of the monovalent tetrafluoroborate based on 100 parts by mass of the urethane prepolymer. Also, when the elastic layer is formed by the one-shot process, the polyurethane raw material to be used is preferable to contain 1-50 parts by mass of the polyisocyanate and 0.1-10 parts by mass of the monovalent tetrafluoroborate based on 100 parts by mass of the polyol. When the amount of the monovalent tetrafluoroborate used is less than 0.1 part by mass, the dependence of the elastic layer on the environment cannot be sufficiently reduced, while when it exceeds 10 parts by mass, the monovalent tetrafluoroborate separates out without being dissolved in the polyurethane, and hence there may be caused a fear that the accuracy of an outer diameter is deteriorated.

The polyurethane raw material may further contain a catalyst, a foam stabilizer, an electron conductive agent and so on in addition to the urethane prepolymer, the polyol, the polyisocyanate and the monovalent tetrafluoroborate.

The catalyst which may be used as the polyurethane raw material is a catalyst for urethanation reaction. As the catalyst are concretely mentioned organotin compounds such as dibutyltin dilaurate, dibutyltin diacetate, dibutyltin thiocarboxylate, dibutyltin dimaleate, dioctyltin thiocarboxylate, tin octoate and the like; organolead compounds such as lead octoate and the like; monoamines such as triethylamine, dimethyl cyclohexylamine and the like; diamines such as tetramethyl ethylenediamine, tetramethyl propanediamine, tetramethyl hexanediamine and the like; triamines such as pentamethyl diethylenetriamine, pentamethyl dipropylenetriamine, tetramethylguanidine and the like; cyclic amines such as triethylenediamine, dimethyl piperazine, methyl ethyl piperadine, methyl morpholine, dimethyl aminoethyl morpholine, dimethyl imidazole and the like; alcohol amines such as dimethylaminoethanol, dimethylaminoethoxyethanol, trimethylaminoethyl ethanolamine, methyl hydroxyethyl piperazine, hydroxyethyl morpholine and the like; ether amines such as bis(dimethylaminoethyl) ether, ethyleneglycol bis(dimethyl) aminopropyl ether and the like. Among them, the organotin compounds are preferable. These catalysts may be used alone or in a combination of two or more. The amount of the catalyst used is preferable to be within a range of 0.01-5 parts by mass based on 100 parts by mass of the polyol in the one-shot process, and it is preferable to be within a range of 0.01-5 parts by mass based on 100 parts by mass of the urethane prepolymer in the prepolymer process. Moreover, the tin-based catalyst can progress the reaction owing to its high activity even if the addition amount is small, while when the amine-based catalyst is used, the addition amount is necessary to be large.

As the foam stabilizer which may be used as the polyurethane raw material are mentioned silicone-based foam stabilizers such as polyether-modified silicone oil and the like, as well as ionic surfactants, nonionic surfactants and so on. The amount of the foam stabilizer used is preferable to be within a range of 3-10 parts by mass based on 100 parts by mass of the polyol in the one-shot process, and it is preferable to be within a range of 3-10 parts by mass based on 100 parts by mass of the urethane prepolymer in the prepolymer process.

As the electron conductive agent which may be used as the polyurethane raw material are mentioned conductive carbons such as Ketjen black, acetylene black and the like; carbon blacks for rubber such as SAF, ISAF, HAF, FEF, GPF, SRF, FT, MT and the like; carbon black for coloring agent treated by oxidation or the like; pyrolyzed carbon black, natural graphite, artificial graphite; metal oxides such as antimony-doped tin oxide, ITO, tin oxide, titanium oxide, zinc oxide and the like; metals such as nickel, copper, silver, germanium and the like; conductive polymers such as polyaniline, polypyrrole, polyacetylene and the like; conductive whiskers such as carbon whisker, graphite whisker, titanium carbide whisker, conductive potassium titanate whisker, conductive barium titanate whisker, conductive titanium oxide whisker, conductive zinc oxide whisker and the like. The amount of the electron conductive agent used is preferable to be within a range of 1-5 parts by mass based on 100 parts by mass of the polyol in the one-shot process, and it is preferable to be within a range of 1-5 parts by mass based on 100 parts by mass of the urethane prepolymer in the prepolymer process. Moreover, the conductive roller according to the invention may not contain the electron conductive agent as a conductive agent, or may contain only the monovalent tetrafluoroborate as a conductive agent.

The elastic layer is preferable to have a resistance value of 10²-10⁷ Ω by compounding the monovalent tetrafluoroborate and the electron conductive agent. When the resistance value of the elastic layer is less than 10² Ω, for example, if the conductive roller is used as a developing roller, charge may leak to the photosensitive drum and so on, or the developing roller itself may be broken due to the voltage, while when it exceeds 10⁷ Ω, fog easily occurs.

For example, the conductive roller according to the invention can be made by injecting the polyurethane raw material into a mold having a desired form, in which the metal shaft is disposed at its center portion, with mixing and stirring, and then curing it. Furthermore, a resin layer or the like may be formed on the outer surface of the conductive roller.

<Image Forming Apparatus>

The image forming apparatus according to the invention is characterized by comprising the above-mentioned conductive roller, in which the conductive roller is preferably used as at least one of a developing roller, a charging roller, a toner supplying roller and a transfer roller. The image forming apparatus according to the invention is not particularly limited as far as it comprises the conductive roller, and can be made according to the known method.

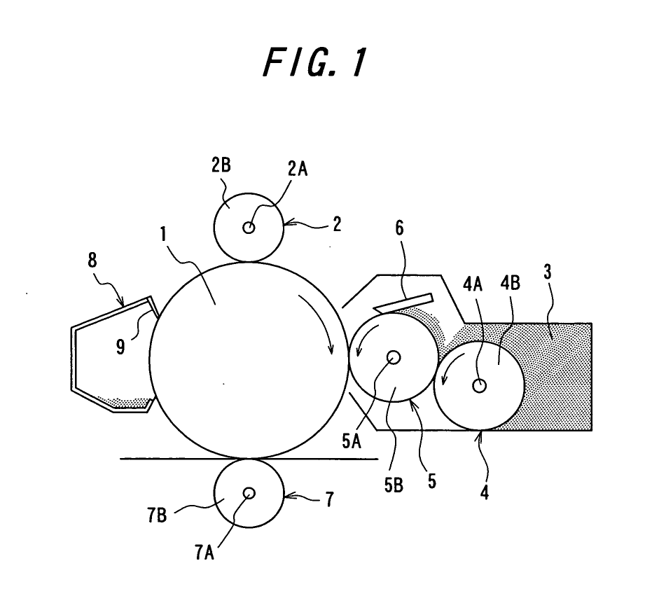

The image forming apparatus according to the invention will be described in detail below with reference to FIG. 1. The illustrated image forming apparatus comprises a photosensitive drum 1 carrying an electrostatic latent image, a charging roller 2 positioned near (upside in the figure) to the photosensitive drum 1 and for charging the photosensitive drum 1, a toner feed roller 4 for supplying a toner 3, a developing roller 5 disposed between the toner feed roller 4 and the photosensitive drum 1, a layer forming blade 6 disposed near (upside in the figure) to the developing roller 5, a transfer roller 7 positioned near (downside in the figure) to the photosensitive drum 1, and a cleaning portion 8 disposed adjacent to the photosensitive drum 1. Moreover, the image forming apparatus according to the invention may further comprise known members (not shown) usually used for the image forming apparatus. The charging roller 2, the toner feed roller 4, the developing roller 5 and the transfer roller 7 in the illustrated image forming apparatus comprise shafts 2A, 4A, 5A, 7A and elastic layers 2B, 4B, 5B, 7B formed on the outer periphery of the shafts, respectively.

In the illustrated image forming apparatus, the charging roller 2 is contacted with the photosensitive drum 1, and the voltage is applied between the photosensitive drum 1 and the charging roller 2 to charge the photosensitive drum 1 at a constant electric potential and then an electrostatic latent image is formed on the photosensitive drum 1 by an exposure machine (not shown). Then, the toner 3 is supplied from the toner feed roller 4 to the photosensitive drum 1 through the developing roller 5 by rotating the photosensitive drum 1, the toner feed roller 4 and the developing roller 5 in the direction shown by arrows in the figure. The toner 3 on the developing roller 5 is made to a uniform thin layer by the layer forming blade 6, while since the developing roller 5 and the photosensitive drum 1 are rotated with contacting each other, the toner 3 is attached from the developing roller 5 to the electrostatic latent image on the photosensitive drum 1 to visualize the latent image. The toner 3 attached to the latent image is transferred to a recording medium such as a paper or the like by the transfer roller 7, while the remaining toner 3 on the photosensitive drum 1 after the transferring is removed by a cleaning blade 9 in the cleaning portion 8. In the image forming apparatus according to the invention, it is possible to stably form an excellent image by using the conductive roller of the invention preventing the aforementioned bad conductivity and defective shape as at least one of the charging roller 2, the toner feed roller 4, the developing roller 5 and the transfer roller 7.

### EXAMPLE

The following examples are given in illustration of the invention and are not intended as limitations thereof.

### Comparative Example 1

100 parts by mass of an urethane prepolymer synthesized from tolylene diisocyanate (TDI) and polyether polyol is mixed with 2 parts by mass of acetylene black to prepare an acetylene black dispersed urethane prepolymer as a component A. On the other hand, 30 parts by mass of polyether polyol is mixed with 0.1 part by mass of sodium perchlorate (NaClO₄) with heating at 70° C., and further mixed with 4.5 parts by mass of polyether-modified silicone oil (foam stabilizer) and 0.2 part by mass of dibutyltin dilaurate (catalyst) to prepare a mixture as a component B. Then, the components A and B are foamed by the mechanical froth method and injected into a cylindrical mold having a metal core set therein, and then a conductive roller having an elastic layer composed of polyurethane foam is made by a RIM forming.

### Example 1

A conductive roller is made by the same manner as in Comparative Example 1 except that 0.1 part by mass of sodium tetrafluoroborate (a solution of sodium tetrafluoroborate dissolved in diethyleneglycol monomethyl ether (DEGMME) is used) is used instead of 0.1 part by mass of sodium perchlorate.

### Example 2

A conductive roller is made by the same manner as in Comparative Example 1 except that 0.1 part by mass of sodium tetrafluoroborate (a solution of sodium tetrafluoroborate dissolved in polyether polyol (PPG) is used) is used instead of 0.1 part by mass of sodium perchlorate.

### Comparative Example 2

A conductive roller is made by the same manner as in Comparative Example 1 except that 0.1 part by mass of N3576 (quaternary ammonium salt made by NICCA CHEMICAL) (a solution of quaternary ammonium salt dissolved in diethyleneglycol monomethyl ether (DEGMME) is used) is used instead of 0.1 part by mass of sodium perchlorate.

### Comparative Example 3

Another conductive roller is made by the same manner as in Comparative Example 1 except that 0.1 part by mass of N3576 (quaternary ammonium salt made by NICCA CHEMICAL) (a solution of quaternary ammonium salt dissolved in polyether polyol (PPG) is used) is used instead of 0.1 part by mass of sodium perchlorate.

In the conductive rollers of Comparative Examples 1-3 and Examples 1-2, the elastic layer has a resistance of 10³-10⁴ Ω. Also, each of these conductive rollers is stored under high-temperature and high-humidity conditions of 32.5° C. and 85% RH for a certain period, and thereafter the elastic layer is peeled to visually observe the presence or absence of rust generated on the surface of the metal core. The results are shown in Table 1. In the table,

“◯” means that rust does not occur and the surface is good,

“x” means that rust occurs, and

“xx” means that a large mount of rust occurs.

TABLE 1

| | | Test for Rust Occurrence | | |
|---|---|---|---|---|
| | Ion conductive | Storage Period | | |
| | agent/Solvent | 1 week | 2 weeks | 2 months |
| Comparative | NaClO₄ | ◯ | ◯ | X |
| Example 1 | | | | |
| Example 1 | NaBF₄/DEGMME | ◯ | ◯ | ◯ |
| Example 2 | NaBF₄/PPG | ◯ | ◯ | ◯ |
| Comparative | N3576/DEGMME | X | XX | XX |
| Example 2 | | | | |
| Comparative | N3576/PPG | X | XX | XX |
| Example 3 | | | | |

“◯” means that rust does not occur and the surface is good,
“X” means that rust occurs, and
“XX” means that a large mount of rust occurs.

### Comparative Example 4

100 parts by mass of polyether polyol is mixed with 0.1 part by mass of sodium perchlorate (NaClO₄) with heating at 70° C., and further mixed with 2 parts by mass of Ketjen black and 0.2 part by mass of dibutyltin dilaurate (catalyst) to prepare a mixture, and the mixture is charged into a tank for a component A (polyol component) of a binary type casting machine for polyurethane. On the other hand, tolylene diisocyanate (TDI) is charged into a tank for a component B (isocyanate component) of the casting machine for polyurethane. The components A and B are injected into a cylindrical mold having a metal core set therein while regulating a flow ratio of component A/component B to 102.12 parts by mass/9 parts by mass, and then a conductive roller having an elastic layer composed of polyurethane elastomer is made by a RIM forming.

### Example 3

A conductive roller is made by the same manner as in Comparative Example 4 except that 0.1 part by mass of sodium tetrafluoroborate (a solution of sodium tetrafluoroborate dissolved in diethyleneglycol monomethyl ether (DEGMME) is used) is used instead of 0.1 part by mass of sodium perchlorate.

### Example 4

A conductive roller is made by the same manner as in Comparative Example 4 except that 0.1 part by mass of sodium tetrafluoroborate (a solution of sodium tetrafluoroborate dissolved in polyether polyol (PPG) is used) is used instead of 0.1 part by mass of sodium perchlorate.

### Comparative Example 5

A conductive roller is made by the same manner as in Comparative Example 4 except that 0.1 part by mass of N3576 (quaternary ammonium salt made by NICCA CHEMICAL) (a solution of quaternary ammonium salt dissolved in diethyleneglycol monomethyl ether (DEGMME) is used) is used instead of 0.1 part by mass of sodium perchlorate.

### Comparative Example 6

A conductive roller is made by the same manner as in Comparative Example 4 except that 0.1 part by mass of N3576 (quaternary ammonium salt made by NICCA CHEMICAL) (a solution of quaternary ammonium salt dissolved in polyether polyol (PPG) is used) is used instead of 0.1 part by mass of sodium perchlorate.

In the conductive rollers of Comparative Examples 4-6 and Examples 3-4, the elastic layer has a resistance of 10⁵-10⁶ Ω. Also, 10 each of these conductive rollers is stored under high-temperature and high-humidity conditions of 32.5° C. and 85% RH for various storage periods, and thereafter the presence or absence of rust on the surface of the metal core is observed visually. The results are shown in Table 2.

TABLE 2

| | | Test for Rust Occurrence | | |
|---|---|---|---|---|
| | Ion conductive | Storage Period | | |
| | agent/Solvent | 1 week | 2 weeks | 2 months |
| Comparative | NaClO₄ | ◯ | X | X |
| Example 4 | | | | |
| Example 3 | NaBF₄/DEGMME | ◯ | ◯ | ◯ |
| Example 4 | NaBF₄/PPG | ◯ | ◯ | ◯ |
| Comparative | N3576/DEGMME | X | XX | XX |
| Example 5 | | | | |
| Comparative | N3576/PPG | X | XX | XX |
| Example 6 | | | | |

As seen from the results of Tables 1 and 2, the rust is generated on the surface of the metal core as the storage period under high-temperature and high-humidity conditions is long in the conductive rollers of the Comparative Examples in which perchlorate or quaternary ammonium salt is selected as an ion conductive agent, while the rust is not generated on the surface of the metal core in the conductive rollers of the Examples in which the monovalent tetrafluoroborate is selected as an ion conductive agent, even if the storage period under high-temperature and high-humidity conditions is long.

What is claimed is:

1. A conductive roller comprising a metal shaft and an elastic layer formed on the outer periphery of the metal shaft and composed of a polyurethane foam or a polyurethane elastomer, characterized in that the elastic layer contains a monovalent tetrafluoroborate.

2. A conductive roller according to claim 1, wherein the monovalent tetrafluoroborate is at least one selected from the group consisting of lithium tetrafluoroborate, sodium tetrafluoroborate and potassium tetrafluoroborate.

3. A conductive roller according to claim 1, wherein the elastic layer is formed by a prepolymer process using a polyurethane raw material comprising 1-50 parts by mass of a polyol and 0.1-10 parts by mass of a monovalent tetrafluoroborate based on 100 parts by mass of an urethane prepolymer synthesized from a polyol and a polyisocyanate.

4. A conductive roller according to claim 1, wherein the elastic layer is formed by a one-shot process using a polyurethane raw material comprising 1-50 parts by mass of a polyisocyanate and 0.1-10 parts by mass of a monovalent tetrafluoroborate based on 100 parts by mass of a polyol.

5. A conductive roller according to claim 1, wherein the elastic layer is composed of a polyurethane foam obtained by foaming a polyurethane raw material with mechanical stirring.

6. An image forming apparatus comprising a conductive roller as claimed in any one of claims 1-5.

7. An image forming apparatus according to claim 6, wherein the conductive roller is used as at least one of a developing roller, a charging roller, a toner feed roller and a transfer roller.
